(19) United States
(12) Patent Application Publication
(10) Pub. No.: US 2011/0047086 A1
(43) Pub. Date: Feb. 24, 2011

(54) Evaluating Environmental Sustainability

(75) Inventors: Marc E. Heisterkamp, Portland, OR (US); Guy H. Volz, Matthews, NC (US); Wayne Santos, Alpharetta, GA (US); Robert G. Becker, Charlotte, NC (US); Robin Alexander, Philadelphia, PA (US)

Correspondence Address: BANNER & WITCOFF, LTD;ATTORNEYS FOR CLIENT NUMBER 007131, 10 SOUTH WACKER DR., SUITE 3000, CHICAGO, IL, 60606, US

(73) Assignee: BANK OF AMERICA CORPORATION, Charlotte, NC (US)

(21) Appl. No.: 12/894,610

(22) Filed: Sep. 30, 2010

Related U.S. Application Data
(63) Continuation-in-part of application No. 11/939,852, filed on Nov. 14, 2007.

(51) Int. Cl. G06Q 50/00

(52) U.S. Cl. 705/314

(57) ABSTRACT

A system and method may automatically receive an electronic lease or other agreement document for property and parse the document to identify provisions provided therein. The lease may then be evaluated for various types of provisions to determine an overall quality score. In one example, the quality score may correspond to an environmental sustainability score and include considerations such as sub-metering, water-saving fixtures, LEED certification and the like. In one or more arrangements, provisions may be identified by generating and providing an electronic questionnaire through which a user may specify the applicable terms of the lease. Approval of the lease may be conditioned on a minimum environmental sustainability score as determined by the lease provisions. A system may further suggest ways to improve the environmental sustainability score.

### CROSS-REFERENCE TO RELATED APPLICATION

This application is a continuation-in-part of U.S. application Ser. No. 11/939,852, entitled “DETERMINING LEASE QUALITY,” and filed Nov. 14, 2007, the content of which is incorporated herein by reference in its entirety.

### BACKGROUND

Individuals and companies have become increasingly conscious of environmental issues. In addition to an individual's personal life, environmental awareness is also growing among corporations and organizations. For example, many companies and other organizations have begun to require more environmental sensitivity in procuring products, conducting everyday business and evaluating their overall work environment.

### SUMMARY

Aspects of the disclosure relate to systems and methods for determining compliance and/or sensitivity to environmental issues during the process of procuring or leasing property. For example, a property lease or procurement may be evaluated based on various parameters such as whether the property includes or allows water-saving features, recycling, building energy and/or water usage monitoring, sub-metering of energy, water or other utilities and green cleaning. Accordingly, in one example, a metric may be used to score a property lease to determine whether the parameters of the lease are favorable from an environmental standpoint. Other, non-environmental factors may also be factored into the lease score depending on the needs or preferences of the company or individual leasing the property.

According to another aspect, suggestions for improving a lease from an environmental perspective may be automatically generated based on one or more components of a determined lease score. For example, components of a lease score analysis contributing to a lower lease score may be identified as potential areas for improvement. Additionally or alternatively, aspects of the disclosure may provide an automated approval system for approving potential property leases. The approval system may evaluate a potential lease based on multiple factors, one of which may include an environmental sustainability or friendliness score.

This summary is provided to introduce a selection of concepts in a simplified form that are further described below in the Detailed Description. The Summary is not intended to identify key features or essential features of the claimed subject matter, nor is it intended to be used to limit the scope of the claimed subject matter.

### BRIEF DESCRIPTION OF THE DRAWINGS

The foregoing summary of the claimed subject matter, as well as the following detailed description of illustrative embodiments, is better understood when read in conjunction with the accompanying drawings, which are included by way of example, and not by way of limitation with regard to the claimed subject matter.

FIG. 1 illustrates a computing environment in which one or more aspects described herein may be implemented.

FIG. 2 illustrates a transaction processing environment according to one or more aspects described herein.

FIG. 3 is a flowchart illustrating a method for determining a lease quality index and a commission according to one or more aspects described herein.

FIG. 4 is a flowchart illustrating a method for determining performance benchmarks and baselines according to one or more aspects described herein.

FIG. 5 illustrates a data entry form interface for entry and submission of lease quality information according to one or more aspects described herein.

FIG. 6 illustrates a quality parameter scoring rubric according to one or more aspects described herein.

FIG. 7 illustrates another example scoring rubric according to one or more aspects described herein.

FIG. 8 is a flowchart illustrating an example method for determining an environmental sustainability score for a lease according to one or more aspects described herein.

FIGS. 9A-9C illustrate example interfaces through which environmental sustainability parameters may be specified according to one or more aspects described herein.

FIG. 10 illustrates an example interface for evaluating secondary environmental sustainability parameters according to one or more aspects described herein.

FIG. 11 illustrates an example environmental sustainability score summary according to one or more aspects described herein.

FIG. 12 is a flowchart illustrating an example method for generating environmental sustainability score improvements according to one or more aspects described herein.

### DETAILED DESCRIPTION

In the following description of various illustrative embodiments, reference is made to the accompanying drawings, which form a part hereof, and in which is shown, by way of illustration, various embodiments in which the claimed subject matter may be practiced. It is to be understood that other embodiments may be utilized and structural and functional modifications may be made without departing from the scope of the present claimed subject matter.

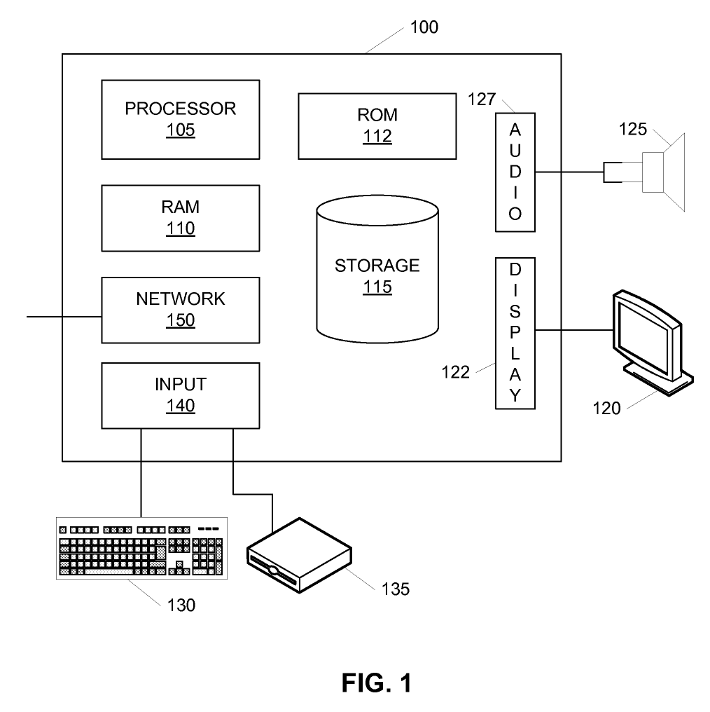

FIG. 1 illustrates a computing environment in which one or more aspects described herein may be implemented. A computing device such as computer 100 may house a variety of components for inputting, outputting, storing and processing data. For example, processor 105 may perform a variety of tasks including executing one or more applications, retrieving data from a storage device such as storage 115 and/or outputting data to a device such as display 120. Processor 105 may be connected to Random Access Memory (RAM) module 110 in which application data and/or instructions may be temporarily stored. RAM module 110 may be stored and accessed in any order, providing equal accessibility to the storage locations in RAM module 110. Computer 100 may further include Read Only Memory (ROM) 112 which allows data stored thereon to persist or survive after computer 100 has been turned off. ROM 112 may be used for a variety of purposes including for storage of computer 100's Basic Input/Output System (BIOS). ROM 112 may further store date and time information so that the information persists even through shut downs and reboots. In addition, storage 115 may provide long term storage for a variety of data including applications and data files. Storage 115 may include any of a variety of computer readable mediums such as disc drives, optical storage mediums, magnetic tape storage systems, flash memory and the like. In one example, processor 105 may retrieve an application from storage 115 and temporarily store the instructions associated with the application RAM module 110 while the application is executing.

Computer 100 may output data through a variety of components and devices. As mentioned above, one such output device may be display 120. Another output device may include an audio output device such as speaker 125. Each output device 120 and 125 may be associated with an output adapter such as display adapter 122 and audio adapter 127, which translates processor instructions into corresponding audio and video signals. In addition to output systems, computer 100 may receive and/or accept input from a variety of input devices such as keyboard 130, storage media drive 135 and/or microphone (not shown). As with output devices 120 and 125, each of the input devices 130 and 135 may be associated with an adapter 140 for converting the input into computer readable/recognizable data. In one example, voice input received through microphone (not shown) may be converted into a digital format and stored in a data file. In another example, credit card input may be received through a card reader (not shown) and converted into a digital format. In one or more instances, a device such as media drive 135 may act as both an input and output device allowing users to both write and read data to and from the storage media (e.g., DVD-R, CD-RW, etc.).

Computer 100 may further include one or more communication components for receiving and transmitting data over a network. Various types of networks include cellular networks, digital broadcast networks, Internet Protocol (IP) networks and the like. Computer 100 may include adapters suited to communicate through one or more of these networks. In particular, computer 100 may include network adapter 150 for communication with one or more other computer or computing devices over an IP network. In one example, adapter 150 may facilitate transmission of data such as electronic mail messages and/or financial data over a company or organization's network. In another example, adapter 150 may facilitate transmission or receipt of information from a world wide network such as the Internet. Adapter 150 may include one or more sets of instructions relating to one or more networking protocols. For example adapter 150 may include a first set of instructions for processing IP network packets as well as a second set of instructions associated with processing cellular network packets. In one or more arrangements, network adapter 150 may provide wireless network access for computer 100.

One of skill in the art will appreciate that computing devices such as computer 100 may include a variety of other components and is not limited to the devices and systems described in FIG. 1.

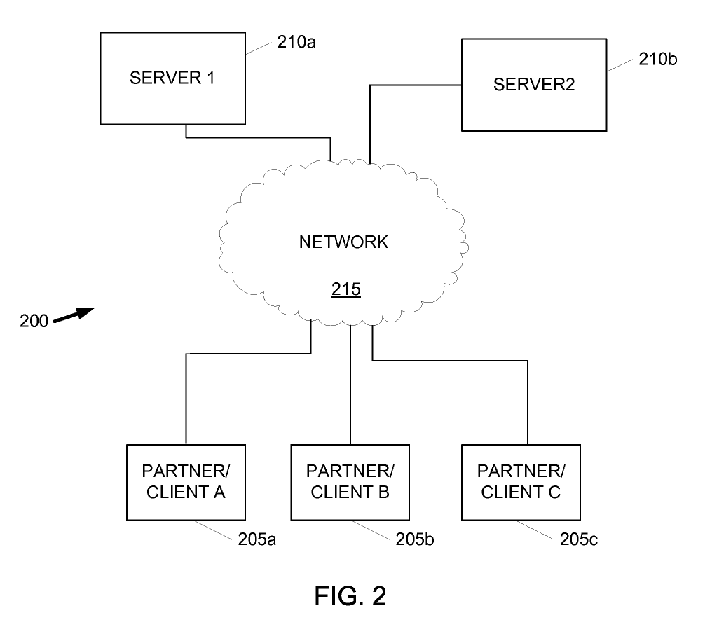

FIG. 2 illustrates a network environment in which a user may submit lease or contract information to an entity for evaluation and analysis. Network environment 200 includes client devices 205 and server 210. Client devices 205 may include mobile communication devices, personal computer (e.g., computer 100 of FIG. 1), personal data assistants (PDA) and the like. Each server 210a and b may correspond to a different entity or may be associated with the same entity. In one example, servers 210 may correspond to a financial company involved in the acquisition, renewal and disposition of various leases including property leases, product leases and the like. Client devices 205 may be associated with various partner entities that manage the leasing process for a particular lease. Such client or partner entities may include brokers, property management companies, agents and/or attorneys. Thus, in one or more arrangements, a server entity such as a financial company may hire a client entity such as a broker to obtain a lease for a particular piece of real estate. Client devices 205 may be used to enter and transmit information regarding lease terms and information to servers 210 through network 215. Servers 210 may then store the lease terms and information and evaluate the quality of the obtained lease. According to one or more aspects, a commission awarded to a client entity such as a broker may be determined based on the quality of the lease.

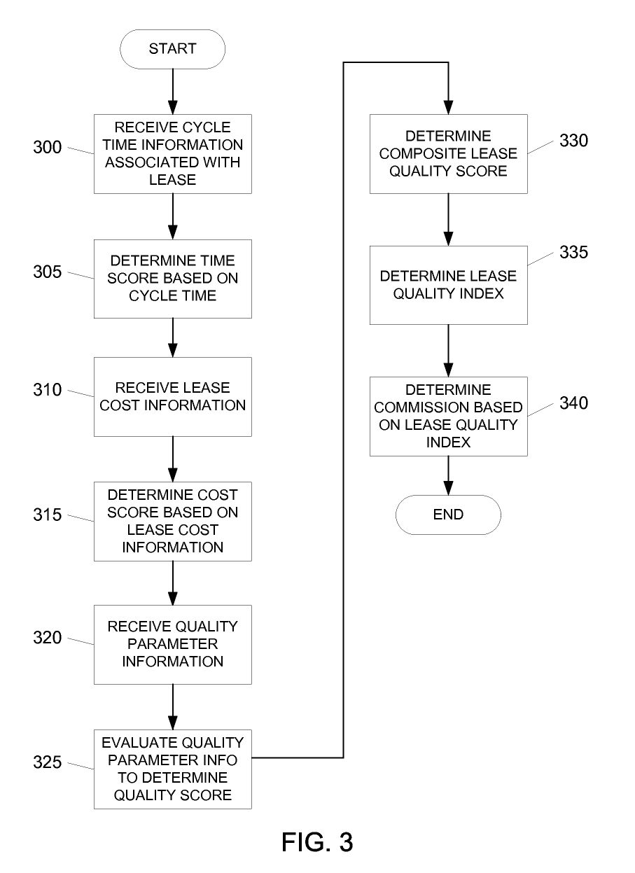

FIG. 3 is a flowchart illustrating a method for evaluating a lease agreement and determining a commission based on the evaluation. In step 300, a lease evaluation server may receive a cycle time that may indicate an amount of time spent obtaining the lease. A cycle time may be calculated based on a time lapsed between when a lease request is chartered and when a lease is approved (e.g., by the chartering entity). In step 305, the lease evaluation server may determine a time score based on the calculated cycle time. For example, the time quality score may be determined by comparing the cycle time to a scoring rubric that assigns points to various cycle times. In one arrangement, the scoring rubric may be derived from market data (e.g., lease completion times in the commercial real estate market or the automobile leasing market). In step 310, the lease evaluation server may receive cost information relating to the cost of the lease. A cost may be defined as the lease cost for a predefined amount of time, e.g., 1 month or 1 year. In step 315, a cost score may be determined based on the determined cost, e.g., by comparing the determined cost with a cost scoring rubric. In step 320, the server may receive quality parameter information associated with the lease agreement. The quality information may include lease provisions such as termination rights, expansion rights, signage provisions, right of first offer/refusal conditions (i.e., renewal options), exclusivity, sub-lease/assignment provisions and the like. In step 325, the quality information of the lease agreement may be evaluated to determine a quality score. For example, quality may be scored by totaling a number of points achieved by the lease agreement. Thus, if a lease agreement includes a termination right, a first number of points may be added to the quality score. Further, if the termination right lasts at least 50% of the life of the lease, a second number of points may also be added to the quality score. According to one or more aspects, a scoring rubric may be derived based on a valuation of various lease terms. Various quality criteria and scoring systems may also be used.

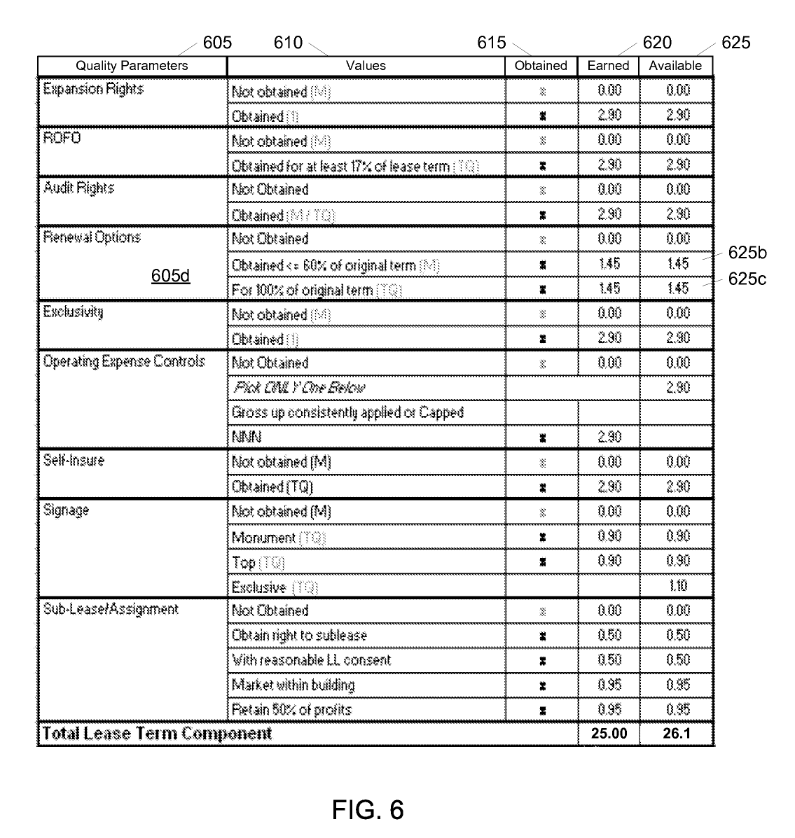

FIG. 6, for example, illustrates a quality parameters scoring chart or rubric. Chart 600 might or might not be provided to a partner entity. Chart 600 includes quality parameters 605, parameters values 610, obtained column 615, earned points 620 and available points 625. Parameter values 610 may be specific to each of quality parameters 605. For example, expansion rights parameter 605d may include values such as not obtained, obtained for <=60% of the original term, and obtained for 100% of original term. In one example, a partner entity may achieve multiple values such as obtained with 100% of original term. In such a case, corresponding points 625b and c may be awarded to the partner entity. The earned points may be identified in earned points column 620. A similar scoring chart or rubric may also be defined and used for evaluating time and cost aspects of a lease. For example, different number of points may be assigned for different lengths of completion time.

Referring again to FIG. 3, in step 330, a composite lease quality score may be determined based on the time, cost and quality scores determined in the steps described above. In one example, the composite lease quality score may be determined by adding each of the time, cost and quality scores. Alternatively or additionally, one or more of the component scores (i.e., time, cost and quality scores) may be weighed differently than the other scores. Various other algorithms may also be used to determine the composite quality score. In step 335, a lease quality index may be determined based on the composite lease quality score. In one or more arrangements, the lease quality index may correspond to the composite lease quality score. Alternatively or additionally, the lease quality index may represent where the composite lease quality score falls on a quality score curve. Once the lease quality index has been calculated, a commission may be determined for the broker or client that procured the lease in step 340. The commission may be a standard commission if the lease quality index corresponds to an average quality index (e.g., index corresponding to a media composite quality score). If, however, the lease quality index is greater than an average quality index, a bonus or a higher commission may be awarded. Alternatively or additionally, if the lease quality index is below average, the standard commission may be reduced.

In one or more configurations, the steps described with respect to FIG. 3 may be performed in a variety of orders. For example, the time, cost and quality score determination steps may be performed in any order and is not restricted to the order in which they are described herein.

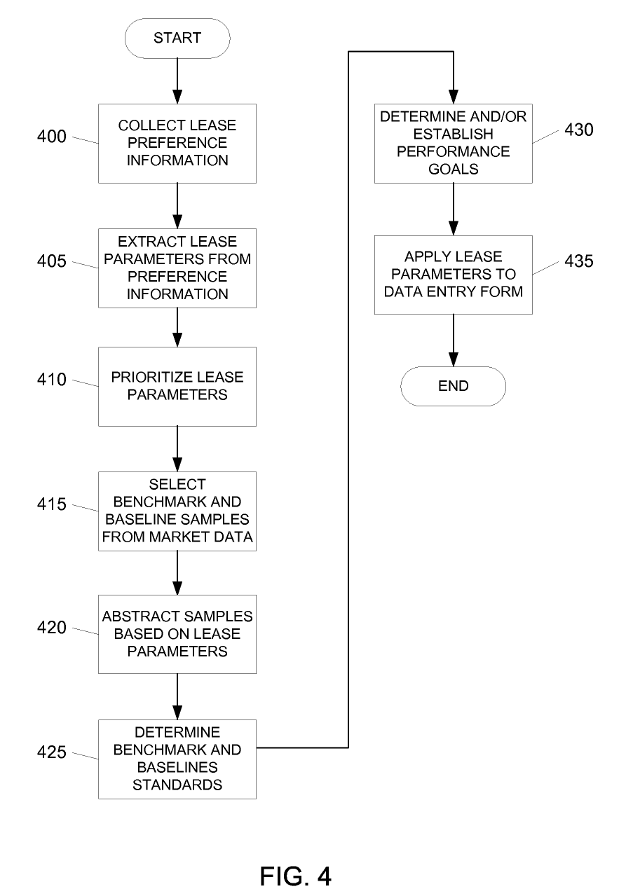

FIG. 4 is a flowchart illustrating a method for developing benchmarks and baselines for a lease quality index. In step 400, information regarding lease preferences may be collected from a variety of sources including lessees, loan officers, banks and the like. Lease preferences may include ideal or preferred cost ranges, time to delivery considerations and/or lease provisions that are desirable or undesirable. In step 405, lease quality parameters may be extracted from the information collected in step 400. That is, the preferred cost range, time to delivery and/or preferred lease provisions are identified from the collected data. In step 410, the various lease quality parameters may be prioritized. In one or more arrangements, the prioritization of the parameters may be performed based on input from interested parties. In step 415, benchmark and baseline samples may be selected from a pool of market data. Benchmark samples generally relate to data collected from external sources (e.g., leases completed by external entities), while baseline samples relate to samples selected from internal data (e.g., leases complete for internal entities). In one example, baseline samples may be selected from leases completed for a banking company while benchmark samples may be selected from leases completed for entities other than the banking company.

In step 420, the benchmark and baseline samples may be abstracted according to the extracted lease quality parameters. For example, a cost and time to delivery may be determined for each sample. Additionally or alternatively, the existence and/or extent of provisions specified in the lease quality parameters may be determined from each sample. In one example, a signage provision may have been identified as an important or otherwise significant lease quality parameter. In such a case, each sample may be evaluated to determine whether a signage provision exists and if so, the scope and coverage of the provision (e.g., duration of rights, size of signs). Once the samples have been analyzed according to the lease quality parameters, benchmark performance and baseline standards may be determined from the abstracted data in step 425. Benchmark and baseline standards may be determined, for example, by calculating a median value for each parameter in each of the benchmark samples and baseline samples. In step 430, performance goals may be established based on the determined benchmark and baseline standards. In one example, if benchmark samples show a higher average or median cost than the average or median cost of the baseline samples (or vice versa), a performance goal for cost may be set between the two samples.

In one or more arrangements, the extracted parameters may be applied to a data entry form or application used by brokers or other leasing partners to enter data relating to various leases in step 435. For example, a data collection template may be formed based on the identified parameters. Subsequently, the template may be used to create a web-entry form accessible through a network such as the Internet, allowing brokers and other partners to enter lease related information.

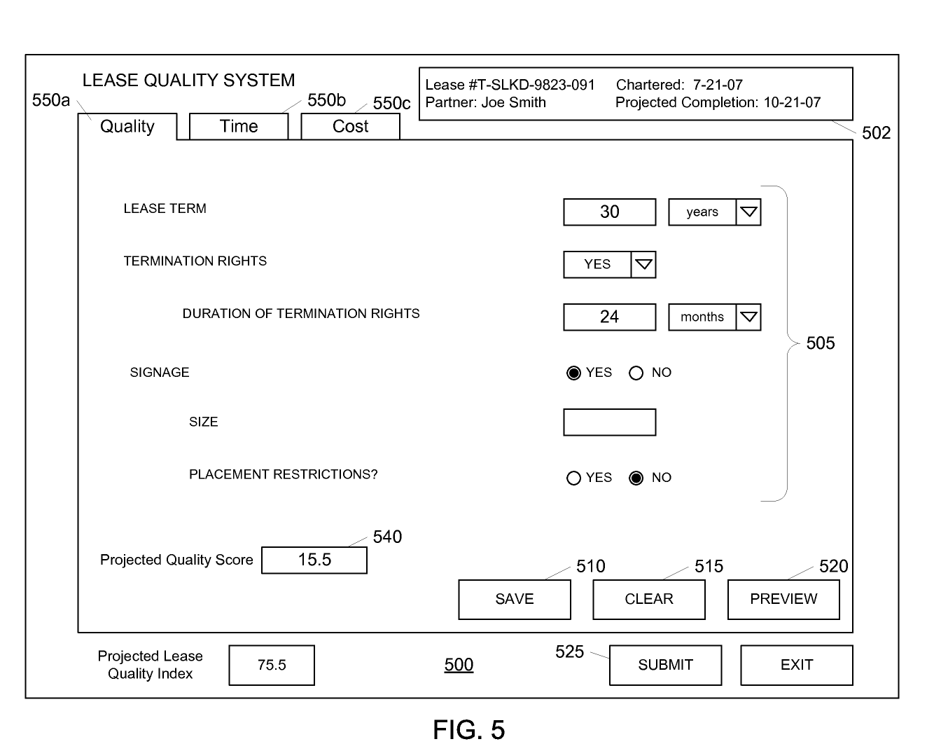

FIG. 5 illustrates a user interface through which a partner entity may enter lease quality information. Data entry form 500 may include lease identification information 502, multiple entry slots 505 corresponding to various time, cost and/or quality parameters, save option 510, clear option 515, preview option 520 and submit option 525. Lease identification information 502 may include a lease ID such as a number or alphanumeric code, date chartered, expected completion date, name of partner entity and the like. Entry slots 505 may include a variety of data input methods such as drop down menus, free-form entry slots, radio buttons and the like. In one or more configurations, a partner entity might not be required to complete all of the data entry slots 505. Instead, the partner entity may enter data in some slots, save the data, e.g., using save option 510, and recall the form at a later time when the partner entity is ready to enter additional information. Clear option 515 may be used by a partner entity to erase data entered in the form. Preview option 520, on the other hand, may allow a partner entity to view the data and/or form as it will be submitted to a reviewing entity. Once the partner entity has completed the form and/or is ready to submit the data to a review entity, the partner entity may select submit option 525.

Additionally or alternatively, form 500 may include quality index information such as a projected quality index 530. The projected quality index 530 may be provided to help a partner entity determine what parameters need to be adjusted in order to increase the projected index. Each component score, e.g., the projected quality score 540, may also be shown in form 500. Tabs 550 corresponding to various categories of lease parameters (e.g., time, cost and/or quality) may be included in form 500 for ease of viewing and entry. Thus, time parameters may be located on a first page identified by tab 550b while cost parameters may be located on a second page identified by tab 550c.

While lease quality indices have been discussed herein as being determined based on a combination of time, cost and quality parameters, a lease quality index may be determined based on a fewer or greater number of parameters. Thus, in one example, a lease quality index may be determined based on cost and quality parameters only or time and cost only or time, cost, quality and a fourth parameter such as partner responsiveness to inquiries. Further such lease quality indices may be used to evaluate not only new leases, but also dispositions, renewals and other lease transaction types. In a renewal, for example, a lease cost may be evaluated based on a comparison of a new lease cost and an old lease cost. Thus, if a partner entity is able to obtain a new lease cost that is 75% of the old lease cost, the cost score may be increased.

Additionally or alternatively, the methods and systems described herein may also be applied to instances where a partner entity is obtaining a lease for a lessor (i.e., rather than for a lessee). In such cases, the absence of certain provisions or rights might raise a cost, time or quality score. For example, if the lease is completed without termination rights for the lessee, additional points may be awarded for the quality score. In another example, if the lease cost is 25% more than market or more than a previous lease cost, a cost score may be increased. Further, other types of agreements or contracts may also be evaluated according to the aspects described herein. Quality elements and other components of a lease quality score or index may be modified according to the relevance and/or importance of those factors to the particular type of contract or agreement. For example, automobile leases may be analyzed to determine whether certain quality parameters have been met. In one instance, the procurement of an extended warranty provision may be awarded a first number of points while an extended warranty lasting a specified number of years may be awarded a second number of points (may be added on to the first number of points or may be awarded in place of the first number of points).

In one arrangement, lease renewals and acquisitions may be evaluated for environmental sustainability or friendliness. For example, a lease may be evaluated to determine whether sub-metering is allowed for water, energy or other utilities, whether recycling is allowed or provided by the properties staff, whether the building offers Leadership in Energy and Environmental Design (LEED) and/or ENERGY STAR certifications and the like. An environmental quality score of a lease may be used to evaluate whether a lease satisfies predefined criteria or to determine a degree to which the lease implements or includes such criteria. In some instances, the environmental quality score may be used as a separate measure of lease quality and in other arrangements may be combined with the lease quality index described herein to generate an overall lease quality score.

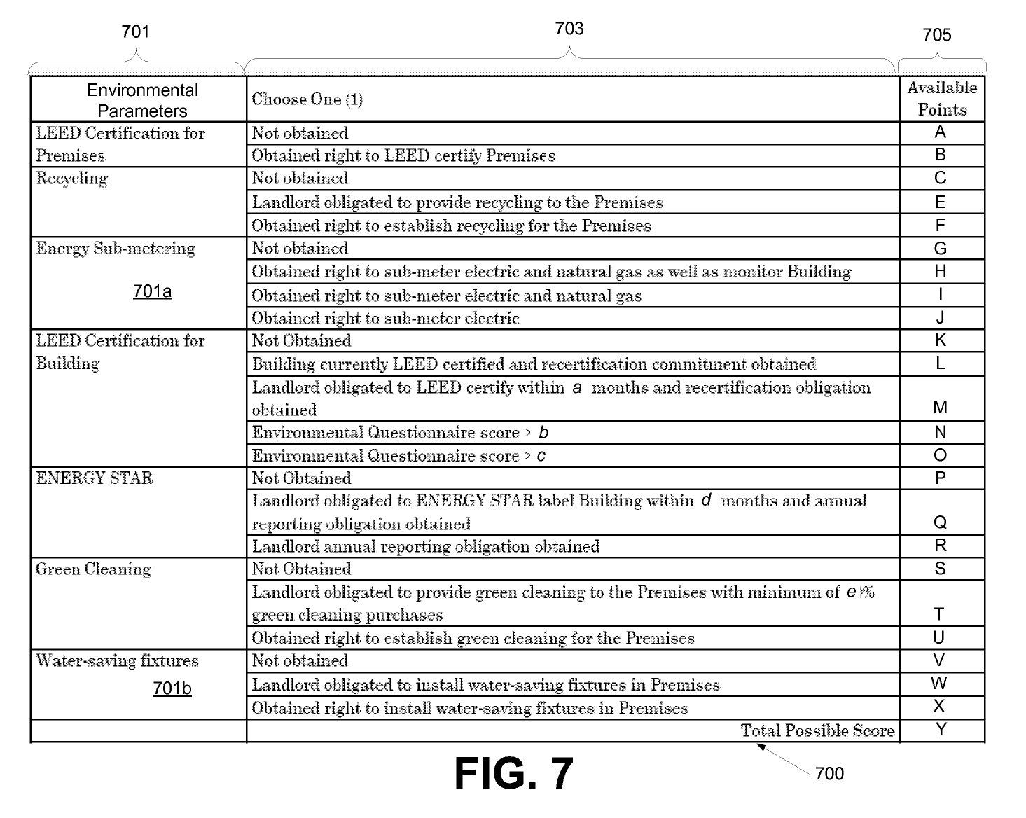

FIG. 7 illustrates an example environmental sustainability scoring rubric. Rubric 700 includes a variety of environmental parameters 701 including (LEED) certification, ENERGY STAR certification, water-saving fixtures and recycling along with potential values 703 for each of parameters 701. In one example, water-saving fixtures parameter 701b may include possible values of “Not obtained”, “Landlord obligated” and “Obtained right.” Not obtained may indicate that there are no rights or obligations for water-saving fixtures, while landlord obligated may refer to a landlord obligation to install water-saving fixtures on the leased premises/property. Obtained right, on the other hand, may provide the lessee with the right to install water-saving fixtures on the premises/property. Each of the values 703 may further be associated with an environmental quality score 705. Scores 705 may be assigned to values 703 based on the degree of desirability from an environmental sustainability perspective. In one example, score V assigned to “Not obtained” may correspond to a value of 0 points while score W assigned to “Landlord obligated” may correspond to a score of 7 points. Thus, if a lease is able to secure a landlord obligated water-saving fixture requirement, the property lease may earn 7 points. An overall score may then be determined by accumulating all of the earned points. The available points 705 shown in FIG. 7 are illustrated using variables A-Y and may represent any value. For example, scores A-Y may be the same or different than other scores. For example, score A may be 0 points, 0.5 points, 1 point, 1.75 points while score Q may be 4 points or 4.2 points or the like.

In another example, points may be awarded if the property lease includes provisions for securing sub-metering or sub-metering rights. Sub-metering 701a may include the monitoring and measuring of a portion of a building or property's usage of a particular resource such as energy or water. Sub-metering may further include direct payment of actual usage rather than prorate shares for overall use (e.g., building use). In the illustrated example scoring rubric 700 of FIG. 7, the possible provisions types for sub-metering 701a include not obtained, obtained right to sub-meter electric and natural gas and to monitor the whole building or property, obtained right to sub-meter electric and natural gas (without monitoring rights) and obtained right to only sub-meter electric.

Examples of other lease provisions that may contribute to an environmental sustainability score include the right to achieve LEED certification for a leased premises (rather than entire building or property as described above), recycling, ENERGY STAR certification, green cleaning and LEED certification for an entire property (e.g., a building) regardless of the portion the lease is intended to cover. ENERGY STAR certification or ratings may be used to identify and compare the energy efficiency of buildings or individual appliances and other energy-consuming devices. This may allow a property owner or lease holder to save on costs while reducing energy consumption. Green cleaning, on the other hand, includes the use of cleaning products that do not include certain types of environmentally-unfriendly chemicals and ingredients. Additionally, green cleaning may include use of cleaning equipment that is recycled or otherwise environment-friendly. In some arrangements, a green cleaning lease score may require a certain percentage of cleaning supplies to be considered environmentally friendly.

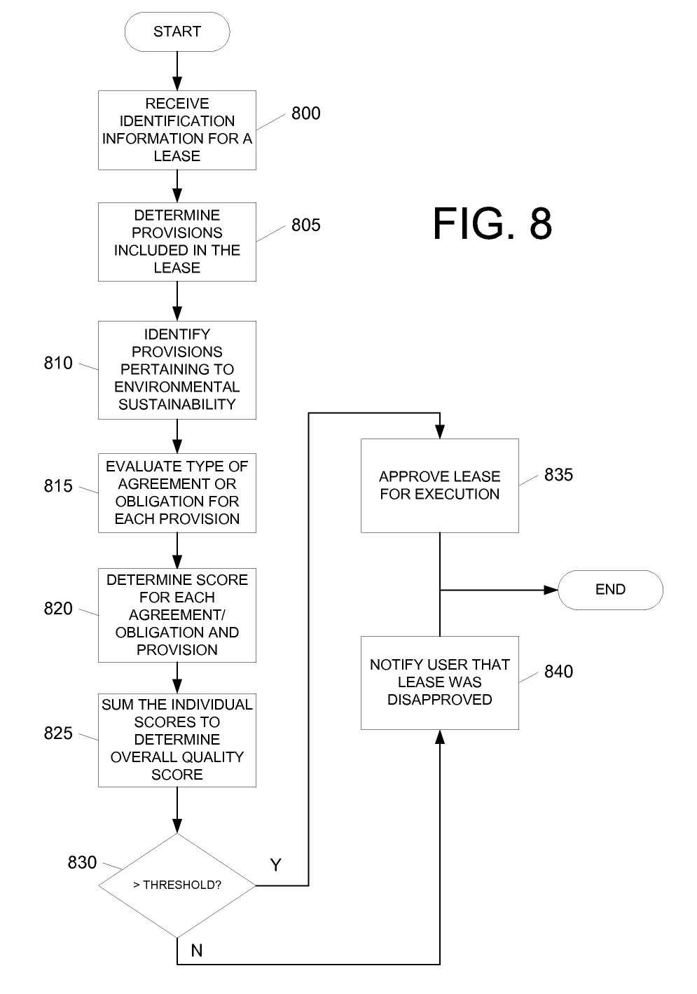

FIG. 8 illustrates an example method for determining an environmental sustainability score for a property lease. First, in step 800, a system may receive identification information for a lease. Lease identification information may include a lease number, a property address, identification of a lessor or landlord, a leasing agent, an employee identifier for an employee handling the leasing negotiations and the like. In some arrangements, a copy of the lease may also be received by the system in step 800. For example, a user may scan in a copy of the lease for review. In another example, the lease may be provided in electronic form (e.g., a fillable PDF document). In step 805, the system may determine provisions included in the property lease. In one example, the system may provide an electronic data entry form requesting that a user specify the types of provisions included in the property lease. In another example, the system may automatically parse an electronic copy of the lease based on spacing, paragraph markings or indicators (e.g., a tab or bullet point), word indicators (e.g., “whereas”), electronic tags (e.g., invisible or visible paragraph markers or provision markers) and/or combinations thereof. In some arrangements, electronic leases may include metadata that identifies the types of provisions included in the lease among other information and data.

Once the provisions have been delineated or determined from step 805, the system may subsequently evaluate the provisions to identify provisions that pertain to environmental sustainability in step 810. In one example, environmental provisions or provisions that are evaluated in determining an environmental sustainability score may be identified automatically by searching for key words or phrases. In a particular example, a water-fixture provision may be automatically identified by searching for the word or phrase “water fixture” or “water-saving.” In another example, LEED provisions may be identified by searching for the word “LEED.” Various other key words or phrases may be used. Alternatively or additionally, a user may manually specify which of the provisions are applicable to the environmental sustainability analysis. That is, a user may specify what environmental provisions are included in the lease through a checklist or questionnaire generated by the system.

In step 815, the system may further evaluate the type of agreement or obligation that is included in each of the identified environmental provisions. For some provisions, only two possible scores may be available (e.g., one score for not obtained and a second score for obtained), while in other instances, more than two possible scores may be defined. For example, the system may determine whether no agreement was reached, whether a right was obtained or whether an obligation was agreed upon. Each of these possible types of agreements or non-agreements may be associated with a different environmental quality score. The determination may be made automatically by identifying key words such as “required,” “obligation” or “right” and evaluating grammatical and language structures for where the words appear in relation to other words (e.g., the name of the lessee or lessor/tenant). Additionally or alternatively, the system may generate and present a user with a questionnaire that allows the user to select the appropriate type of agreement or obligation. The questionnaire may be generated based on predefined questions and answers and might only include questions for the environmental provisions that are determined to be included in the lease. For environmental terms or provisions that are not identified as being part of the lease, a default or automatic response of “not included” may be set.

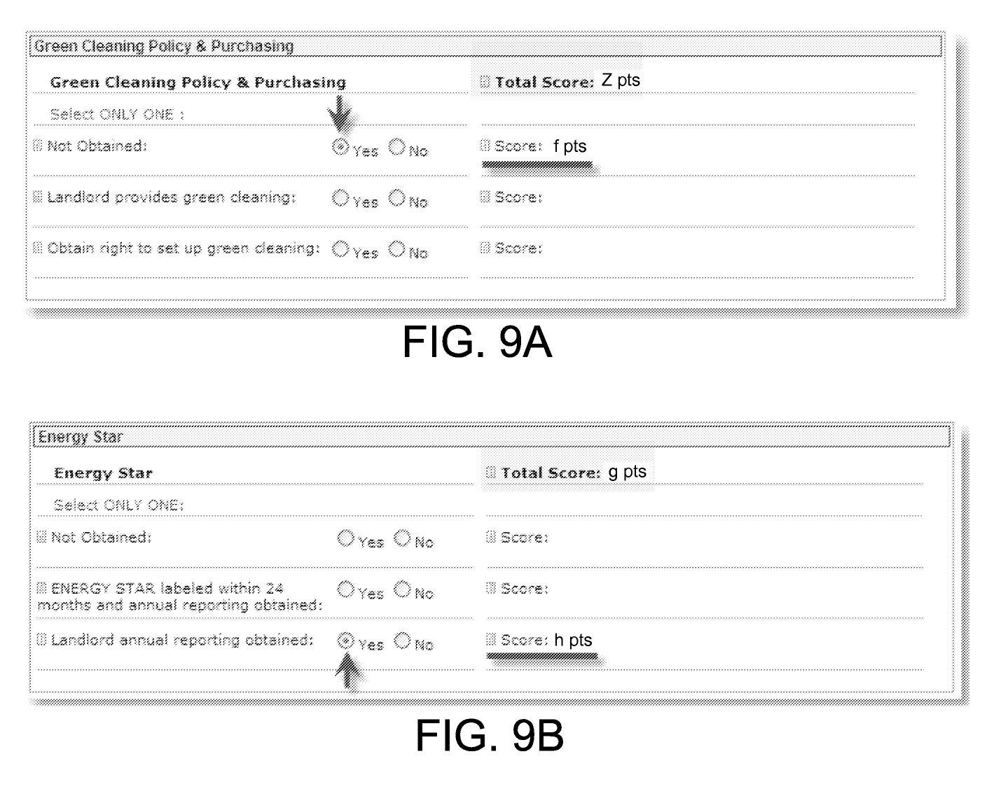

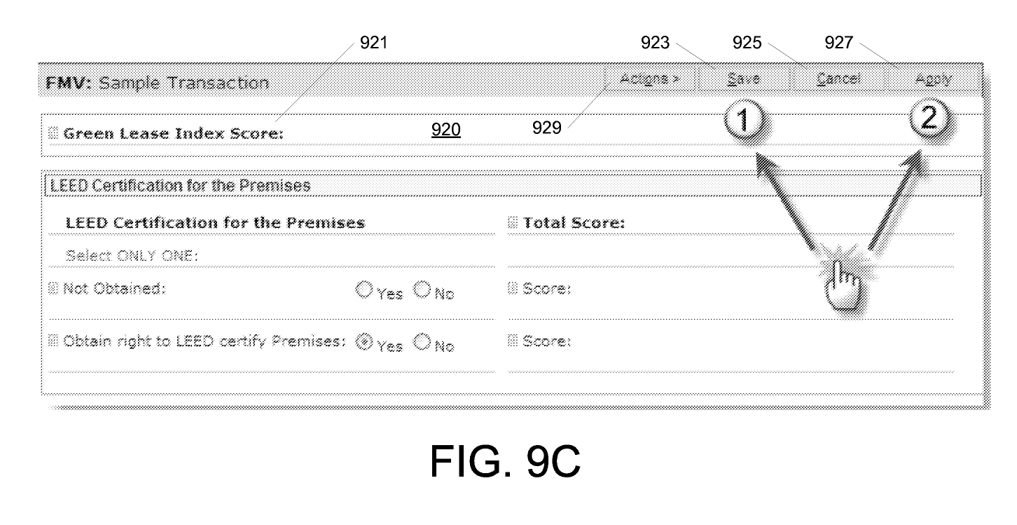

FIGS. 9A-C illustrate example portions of an environmental provisions questionnaire. FIG. 9A, for instance, illustrates a green cleaning policy provision that may or may not be included in a lease. If a green cleaning policy provision is not included in the lease, then the system may assign a first score (e.g., 0, 1, 2, 3, 5, 10) to the green cleaning policy provision of an overall environmental quality score of the lease. If, on the other hand, an obligation for the landlord to provide green cleaning is secured in the lease, a second score may be awarded. Finally, if a right was obtained (e.g., no obligation on part of the landlord) to provide green cleaning for the lease space or property, a third score may be awarded. Each of the first, second and third scores may be different or the same depending on preferences and valuation of the scoring entity. FIG. 9B illustrates another example scoring questionnaire parameter in which ENERGY STAR certification for the building is evaluated. Accordingly, if the lease provides for annual reporting by the landlord, a first score may be awarded while if the lease provides for annual reporting and ENERGY STAR label within 24 months, a second score may be awarded. ENERGY STAR certification or labeling might only be available for those buildings (or individual devices) that achieve a certain threshold ENERGY STAR rating. In some arrangements, the first score and second score may be different (e.g., second score is higher than the first score or vice versa) or the same. Additionally, in each of the scoring questionnaires of FIGS. 9A and 9B, a current total environmental quality score may be displayed to provide the user with an up-to-date value.

FIG. 9C illustrates another example environmental sustainability parameter for evaluating a lease. The interface 920 includes a field that identifies the current overall score 921 as well as options 923, 925 and 927 for saving, cancelling and applying changes to the questionnaire, respectively. In one example, the current overall score 921 might not be updated until a user selects the apply option 927. Additionally or alternatively, save option 923 may automatically save the user's current responses and automatically update the score without the user having to separately interact with the apply option 927. Cancel option 925 may be used to erase all changes made since the questionnaire was last saved and, in some instances, cause the questionnaire to close. Other actions may be provided through actions drop down menu 929.

Returning to FIG. 8, upon determining the type of agreement or obligation (e.g., not obtained, landlord obligated, tenant right) included for each environmental provision in the lease (and, in some cases, those that are not), the system may determine a score for each of the environmental provisions of the lease in step 820. The score may reflect the strength or significance of the provision. For example, a provision that has a strong requirement or obligation may be awarded more points. In a specific example, an obligation of the landlord may be awarded more points than a right of the lessee (e.g., to install water-saving fixtures). If a provision is not included or the provision does not include any rights or obligations, the provision might not be awarded with any points. In step 825, the points awarded in step 820 may be totaled to determine an overall environmental sustainability quality score for the lease. For example, if a lease achieved 7 points for obtaining an obligation on the part of the landlord to install water-saving fixtures and 5 points for having the right to obtain LEED certification, the lease would be assigned an overall environmental sustainability quality score of 12 points.

Optionally, in step 830, the overall environmental sustainability quality score of the lease may be evaluated to determine if a threshold quality score has been reached. The threshold may be set based on an average environmental quality score of previously approved leases, a score set by an organization or the like. In one example, the threshold quality score may vary depending on building type (e.g., glass, brownstone, brick, etc.), building size (e.g., 8 floors, 432,000 sq. ft., etc.), geographic location (e.g., New York City, Washington, D.C., Kansas City, Mo. within the city, outside of the city, etc.) and/or combinations thereof. In step 835, if the quality score is determined to meet the threshold, the lease may be approved and a user may be notified that the lease may be executed. Alternatively, if the quality score fails to meet the threshold, the system may notify a user that the lease was disapproved based on the environmental quality in step 840.

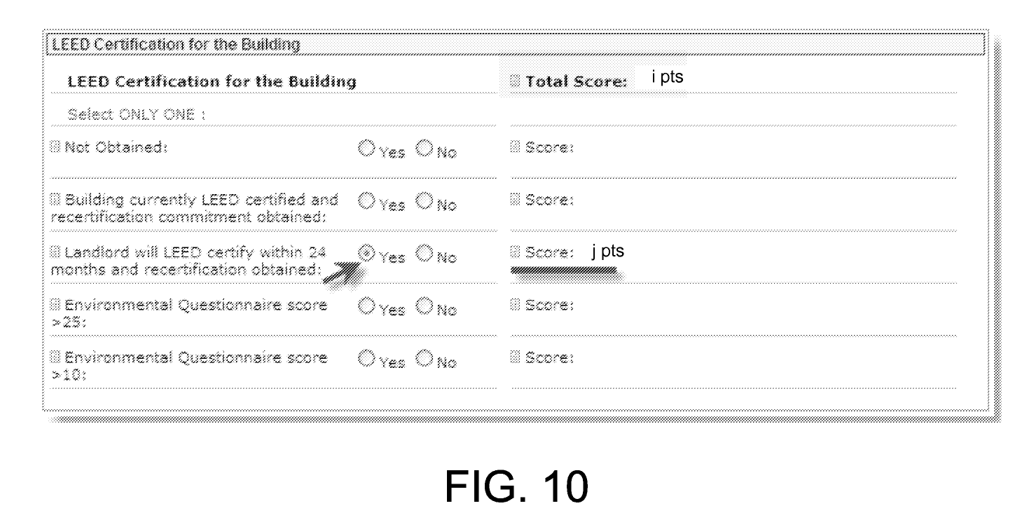

According to one or more aspects, the environmental quality scoring questionnaire may include indirect consideration of other factors that are not specifically included in the scoring questionnaire. For example, the environmental quality scoring questionnaire may evaluate a second questionnaire (different from the environmental quality scoring questionnaire) or questionnaire score. FIG. 10 illustrates an example question on an environmental quality scoring questionnaire that references a second environmental questionnaire and a score achieved in that questionnaire. The second questionnaire may include different questions that relate to other environmental factors. In one particular example, the second questionnaire may pertain to LEED certification and the requirement for achieving such certification. In another example, the second questionnaire may pertain to ENERGY STAR certification/labeling qualification. In some arrangements, the second questionnaire may be completed by an individual or entity different from the entity completing the scoring questionnaire. For example, the second questionnaire may be intended for the landlord or leasing company rather than the tenant or lessor (e.g., for which the scoring questionnaire may be intended).

The scoring questionnaire may thus consider the score achieved in the second questionnaire. In particular and in on example, a number of points may be awarded to the lease if a certain score was achieved in the second questionnaire. For example, if a score over 25 was achieved, a first score may be added to the overall environmental quality score while if a score over 10 was achieved, a second score may be added. The first score may be higher or lower than the second score or, in some arrangements, be the same. The second questionnaire may include considerations such as energy auditing, density/community connectivity, access to public transportation, Brownfield resources, stormwater quality and quantity, light pollution, parking structure, roof solar reflectance index, building plumbing fixtures (e.g., compliance with Universal Plumbing Codes), irrigation, rainwater harvesting and/or wastewater treatment, sustainable purchasing policies, composting, recycling/waste diversion, integrated pest management and/or LEED accredited professional staffing. For example, the second questionnaire may award one or more points for each of using Brownfield resources (e.g., land that is abandoned or underused industrial or commercial facilities) and/or using roofing materials that have a minimum solar reflectance index (SRI) of 78 for low sloped roofs or a minimum of 29 for steep sloped roofs. In one example, the second questionnaire may correspond to a LEED certification standard or guideline.

In some arrangements, the environmental sustainability scoring questionnaire or a secondary questionnaire may include additional questions relating to non-lease provisions that are not scored when determining the environmental sustainability score of the lease. Instead, these parameters may be considered in determining a building's overall environmental sustainability score. For example, environmental provisions that are not scored for the lease's environmental sustainability may include non-smoking requirements, adherence to American Society of Heating, Refrigerating and Air-Conditioning Engineers (ASHRAE) Standards (e.g., Standard 62.1), landlord construction and demolition requirements, green power, carbon/environmental incentives, alternative transportation, water sub-metering and low volatile organic compound (VOC) paints, adhesives and sealants. For example, a property may satisfy green power guidelines by using on-site renewable energy or purchasing of Renewable Energy Certificates (RECs). In another example, a property may comply with alternative transportation requirements by providing onsite secure bicycle storage for a certain percentage or more of an estimated number of occupants of the property. Alternative transportation guidelines may also include requirements for showers or changing rooms (e.g., to increase the feasibility and attractiveness of alternative transportation). These environmental sustainability parameters may be separately scored to determine an overall property score that evaluates a property's environmental sustainability beyond lease-specific terms.

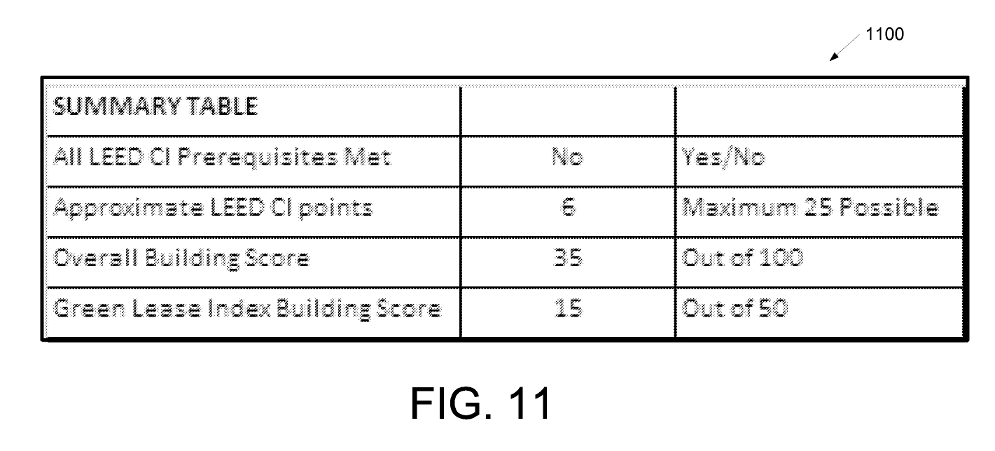

FIG. 11 illustrates an example scoring summary that includes a breakdown of the various environmental sustainability scores/parameters as determined by a system. Summary 1100 includes, for instance, an indication of whether all LEED commercial interior (CI) prerequisites have been met. LEED CI prerequisites may include parameters that must be satisfied before points are awarded for compliance with corresponding LEED guidelines. Summary 1100 may further display the number of LEED CI points accumulated (e.g., the number of points achieved by satisfying LEED guidelines). In one example, this score may be determined based on the responses submitted in a secondary questionnaire such as a LEED checklist. Summary 1100 may further display an overall building score generated based on non-lease specific environmental sustainability parameters (e.g., property wide issues) such as plumbing, smoking area designations, paint toxicity and the like. Finally, summary 1100 may further display the environmental sustainability score for the lease (e.g., as determined in the process illustrated in FIG. 8). For each parameter, the number of possible points or the possible values may be displayed as well.

In some instances, a score summary such as summary 1100 of FIG. 11 may indicate that a lease has a low score and/or does not meet an approval threshold. In such instances, a system may suggest ways in which to improve the lease's environmental sustainability score. The suggestions may be generated automatically if the lease does not meet the threshold, for example, or may be generated in response to a user request.

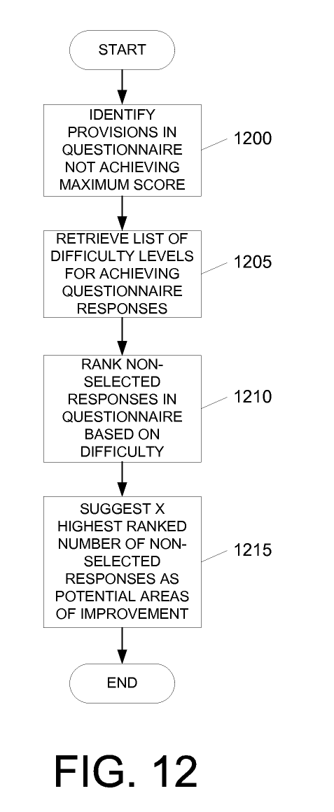

FIG. 12 illustrates an example method for suggesting ways in which an environmental quality score of a lease may be increased. In step 1200, a lease evaluation system may identify provisions in the environmental quality scoring questionnaire for which a maximum number of points have not been awarded. For example, the system may analyze the answers provided by the user to determine whether the highest scoring responses were selected. In step 1205, the lease evaluation system may retrieve a table or list that defines the level of difficulty for implementing or negotiating each of the possible responses in the questionnaire. For example, the table may rank the difficulty of implementing each type of recycling provision on a scale of 1-10 where 10 is the most difficult (e.g. landlord obligated recycling may be a 7 on the scale while a tenant right to establish recycling may be a 3). The table or list may further rank the possible questionnaire responses based on other factors including potential cost, amount of score increase and the like. The lease evaluation system may subsequently rank the higher scoring, but non-selected responses of the identified provisions based on the ranking in the table or list in step 1210. A highest ranking number of higher scoring and non-selected responses may then be suggested as points to further negotiate in the lease in step 1215. The number of suggestions may vary based on user preferences and/or default system settings. In one example, the number of suggestions may correspond to an amount of points needed to reach an approval threshold.

By evaluating leases in the above described manner, significant progress may be achieved in protecting the environment and potentially reversing environmental harm. Leases that do not satisfy a minimum required amount of environmental sustainability may be rejected and/or re-negotiated. The environmental sustainability parameters may further improve the work environment by, for example, introducing less toxic elements into the air. Additionally, resource conservation awareness and education may be heightened by the visibility of the environmentally friendly features that are implemented in the workplace.

The methods and features recited herein may further be implemented through any number of computer readable media that are able to store computer readable instructions. Examples of computer readable media that may be used include RAM, ROM, EEPROM, flash memory or other memory technology, CD-ROM, DVD, or other optical disk storage, magnetic cassettes, magnetic tape, magnetic storage and the like.

While illustrative systems and methods as described herein embodying various aspects are shown, it will be understood by those skilled in the art that the invention is not limited to these embodiments. Modifications may be made by those skilled in the art, particularly in light of the foregoing teachings. For example, each of the elements of the aforementioned embodiments may be utilized alone or in combination or subcombination with elements of the other embodiments. It will also be appreciated and understood that modifications may be made without departing from the true spirit and scope of the present invention. The description is thus to be regarded as illustrative instead of restrictive on the present invention.

We claim:

1. A method comprising:
determining, by an evaluation system, one or more provisions of a property lease, wherein the one or more provisions of the property lease include environmental provisions for a leased property;
assigning a score, by the evaluation system, to each of the one or more provisions of the property lease, wherein the score indicates a degree of compliance with an environmental sustainability guideline for property leases; and
determining an environmental sustainability score for the lease based on the score assigned to each of the one or more provisions of the property lease.

2. The method of claim 1, further comprising determining whether to approve the lease for execution by comparing the environmental sustainability score of the lease with a threshold score.

3. The method of claim 2, wherein the threshold score is selected based on a geographic location of the property.

4. The method of claim 1, wherein determining the one or more provisions of the property lease includes:
receiving an electronic version of the property lease; and
parsing the property lease to identify the one or more provisions.

5. The method of claim 4, wherein parsing the property lease is performed by identifying key words or phrases in the property lease.

6. The method of claim 1, further comprising determining, by the evaluation system, one or more changes to the property lease to improve the environmental sustainability score.

7. The method of claim 1, wherein the one or more provisions includes a certification provision and wherein assigning a score to the certification provision includes determining another score determined based on a certification checklist different from the environmental sustainability guideline for property leases.

8. The method of claim 7, wherein a first score is assigned to the certification provision when the other score determined based on the certification checklist is above a first score threshold and wherein a second score is assigned to the certification provision when the other score is above a second threshold.

9. One or more non-transitory computer readable media storing computer readable instructions that, when executed, cause an apparatus to:
determine one or more provisions of a property lease, wherein the one or more provisions of the property lease include environmental provisions for a leased property;
assign a score to each of the one or more provisions of the property lease, wherein the score indicates a degree of compliance with an environmental sustainability guideline for property leases; and
determine an environmental sustainability score for the lease based on the score assigned to each of the one or more provisions of the property lease.

10. The one or more non-transitory computer readable media of claim 9, wherein determining the one or more provisions of the property lease includes:
receiving an electronic version of the property lease; and
parsing the property lease to identify the one or more provisions.

11. The one or more non-transitory computer readable media of claim 10, wherein parsing the property lease is performed by identifying key words or phrases in the property lease.

12. The one or more non-transitory computer readable media of claim 9, wherein the computer readable instructions, when executed, further cause the apparatus to determine one or more changes to the property lease to improve the environmental sustainability score.

13. The one or more non-transitory computer readable media of claim 9, wherein the one or more provisions include a certification provision and wherein assigning a score to the certification provision includes determining another score determined based on a certification checklist different from the environmental sustainability guideline for property leases.

14. The one or more non-transitory computer readable media of claim 13, wherein a first score is assigned to the certification provision when the other score determined based on the certification checklist is above a first score threshold and wherein a second score is assigned to the certification provision when the other score is above a second threshold.

15. An apparatus comprising:
at least one processor; and
memory operatively coupled to the at least one processor and storing computer readable instructions that, when executed, cause the apparatus to:
determine one or more provisions of a property lease, wherein the one or more provisions of the property lease include environmental provisions for a leased property;
assign a score to each of the one or more provisions of the property lease, wherein the score indicates a degree of compliance with an environmental sustainability guideline for property leases; and
determine an environmental sustainability score for the lease based on the score assigned to each of the one or more provisions of the property lease.

16. The apparatus of claim 15, wherein the computer readable instructions, when executed, further cause the apparatus to determine whether to approve the lease for execution by comparing the environmental sustainability score of the lease with a threshold score.

17. The apparatus of claim 16, wherein the threshold score is selected based on a geographic location of the property.

18. The apparatus of claim 15, wherein determining the one or more provisions of the property lease includes:
receiving an electronic version of the property lease; and
parsing the property lease to identify the one or more provisions.

19. The apparatus of claim 18, wherein parsing the property lease is performed by identifying key words or phrases in the property lease.

20. The apparatus of claim 15, wherein the computer readable instructions, when executed, further cause the apparatus to determine one or more changes to the property lease to improve the environmental sustainability score.
